(19) United States
(12) Patent Application Publication
(10) Pub. No.: US 2014/0153734 A1
(43) Pub. Date: Jun. 5, 2014

(54) MULTIFUNCTION EARPIECE DEVICE

(71) Applicant: Wei-Lun Chen, Hsinchu (TW)

(72) Inventor: Wei-Lun Chen, Hsinchu (TW)

(21) Appl. No.: 13/693,556

(22) Filed: Dec. 4, 2012

(51) Int. Cl. H04R 1/10

(52) U.S. Cl. CPC H04R 1/1041
USPC 381/74

(57) ABSTRACT

A multifunction earpiece device is for receiving a sound signal generated from one of electronic devices and transmitting data and/or power between the electronic devices. The multifunction earpiece device includes a casing, a speaker unit, connectors, and a switching module. The casing has a receiving space therein and holes. The speaker unit is equipped with sound lines connected to the electronic devices through the holes and the receiving space for receiving the sound signal. The connectors protrude from the receiving space through the holes. The connectors are connected to the switching module. After the connectors have been connected to the electronic devices, the switching module changes a direction of transmission of the data and the power between the electronic devices.

### FIELD OF THE INVENTION

The present invention relates to multifunction earpiece device, and more particularly, to a multifunction earpiece device for receiving a sound signal generated by one of a plurality of electronic devices and enabling the electronic devices to transmit data and/or power to each other.

### BACKGROUND OF THE INVENTION

According to the prior art, with a conventional earpiece being portable, the conventional earpiece is an indispensable accessory to portable mobile devices (such as cell phones or tablets) and is effective in converting a sound signal generated from the portable mobile device into sound to which a user listens.

However, what the conventional earpiece can do is no more than transmitting a sound signal and converting the sound signal into the sound.

In the face of technological advancement, it is imperative to enable earpieces to take on additional functions to thereby allow a user to use the earpieces more efficiently.

### SUMMARY OF THE INVENTION

It is an objective of the present invention to provide a multifunction earpiece device for receiving a sound signal generated from one of a plurality of electronic devices and transmitting data and/or power between the electronic devices.

In order to achieve the above and other objectives, the present invention provides a multifunction earpiece device for receiving a sound signal generated from one of a plurality of electronic devices and transmitting at least one of data and power between the electronic devices. The multifunction earpiece device comprises a casing, a speaker unit, a plurality of connectors, and a switching module. The casing has a receiving space therein and a plurality of holes. The speaker unit has a plurality of sound lines and a plurality of speaker singles. One end of each of the sound lines inserts from one of the holes into the receiving space. The sound lines inside the receiving space exit the other one of the holes to connect to the electronic devices for receiving the sound signal. Another end of each of the sound lines is connected to a corresponding one of the speaker singles. The speaker singles convert the sound signal into a sound. The connectors are disposed in the receiving space. The connectors protrude from the receiving space through the holes to thereby connect to the electronic devices. The switching module forms a plurality of path configurations. The switching module is disposed in the receiving space and connected to the connectors. The switching module changes the direction of the transmission of the data and the power between the electronic devices by means of the path configurations.

Compared with the prior art, the present invention provides a multifunction earpiece device that not only receives a sound signal generated from one of a plurality of electronic devices (such as a portable mobile communication device and a notebook computer), but also allows the electronic devices to transmit data and/or power through the path configurations after one of path configurations is selected automatically according to a change (such as high voltage, low voltage, or changes of marginal voltage) in the voltage generated as a result of the connection of the electronic devices having master/slave architectures.

Accordingly, the present invention not only enables a user to receive a sound signal generated from one of a plurality of electronic devices but also enables data and power to be transmitted between the electronic devices.

### BRIEF DESCRIPTION OF THE DRAWINGS

Objectives, features, and advantages of the present invention are hereunder illustrated with specific embodiments in conjunction with the accompanying drawings, in which:

FIG. 1 is a schematic block diagram of a multifunction earpiece device according to an embodiment of the present invention;

FIG. 2 is a schematic block diagram of a switching module of FIG. 1 according to an embodiment of the present invention;

FIG. 3 is a schematic block diagram of a switching module of FIG. 1 according to another embodiment of the present invention;

FIG. 4 is a schematic block diagram of a switch element of FIG. 3; and

FIG. 5 is a schematic block diagram of the switching units of FIG. 2 or FIG. 3.

### DETAILED DESCRIPTION OF THE PREFERRED EMBODIMENTS

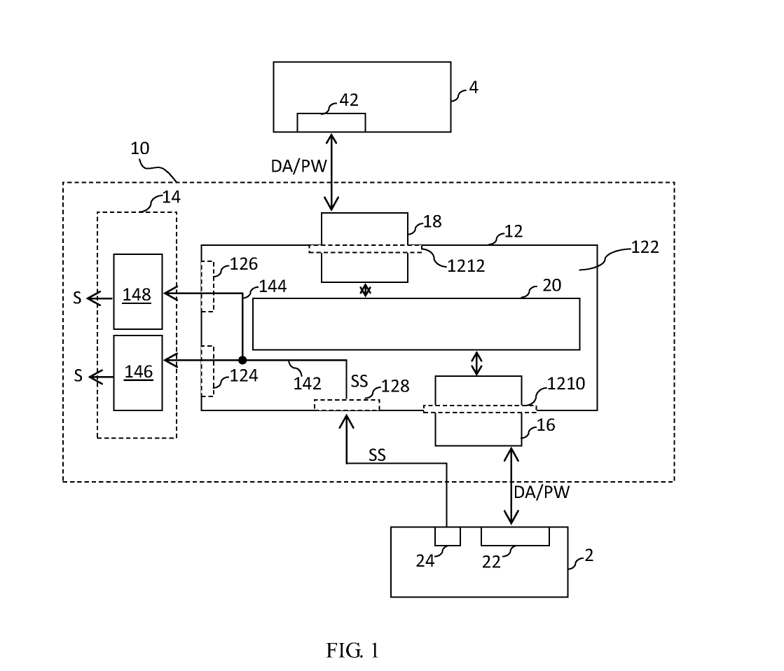

Referring to FIG. 1, there is shown a schematic block diagram of a multifunction earpiece device 10 according to an embodiment of the present invention. As shown in FIG. 1, the multifunction earpiece device 10 receives a sound signal SS generated from an electronic device 2 and transmits data DA and/or power PW between the electronic device 2 and an electronic device 4. The electronic device 2 has a port 22, and an audio aperture 24. The electronic device 4 has a port 42. The electronic devices 2, 4 transmit the data DA and the power PW via the ports 22, 42. The electronic device 2 transmits the sound signal SS through the audio aperture 24. The electronic devices 2, 4 have a master/slave architecture. The electronic devices 2, 4 come in the form of a notebook computer equipped with a battery (not shown) therein, a portable mobile communication device equipped with a battery (not shown) therein, a data storage device, a card reader, and a charger. The battery stores power PW required for operation of the electronic devices 2, 4. The electronic devices 2, 4 are capable of outputting power PW otherwise stored in the battery.

The multifunction earpiece device 10 comprises a casing 12, a speaker unit 14, connectors 16, 18, and a switching module 20.

The casing 12 has a receiving space 122 therein and holes 124, 126, 128, 1210, 1212. For example, the casing 12 is made of metal or polyvinyl chloride (PVC).

The speaker unit 14 has sound lines 142, 144 and speaker singles 146, 148. One end of the sound line 142 inserts from the hole 124 into the receiving space 122. One end of the sound line 144 inserts from the hole 126 into the receiving space 122. The sound lines 142, 144 exist the hole 128 simultaneously to connect to the audio aperture 24 of the electronic device 2 for receiving the sound signal SS from the electronic device 2. The other ends of the sound lines 142, 144 are connected to the speaker singles 146, 148. The speaker singles 146, 148 convert the sound signal SS into a sound S, and the sound S is emitted from the speaker units 146, 148.

Referring to FIG. 1, the connectors 16, 18 are partially positioned inside the receiving space 122. For example, the connectors 16, 18 are at least one of standard universal serial buses, mini universal serial buses, micro universal serial buses, Apple 30-pin connectors, and Apple 8-pin connectors. The connectors 16, 18 stick out from the receiving space 122 through the holes 1210, 1212 to connect with the ports 22, 42 of the electronic devices 2, 4, respectively.

The switching module 20 is disposed inside the receiving space 122 and connected to the connectors 16, 18. A plurality of path configurations (not shown in the diagram but is described in detail below) is formed inside the switching module 20 and adapted to change the direction of transmission of the data DA and the power PW between the electronic devices 2, 4.

For instance, in an exemplary embodiment, where the electronic device 2 is exemplified by a notebook computer, and the electronic device 4 by a portable mobile communication device, if the electronic device 2 and the electronic device 4 are concurrently connected to the switching module 20 via the connectors 16, 18, then the notebook computer will be automatically set to a master control configuration and the portable mobile communication device will be automatically set to a slave control configuration, such that the data DA and the power PW are transmitted between the electronic devices 2, 4 by means of the master/slave architectures.

Furthermore, once the notebook computer separates from the connector 16 (thus leaving alone the portable mobile communication device connected to the switching module 20), the portable mobile communication device will switch from the slave control configuration to the master control configuration automatically.

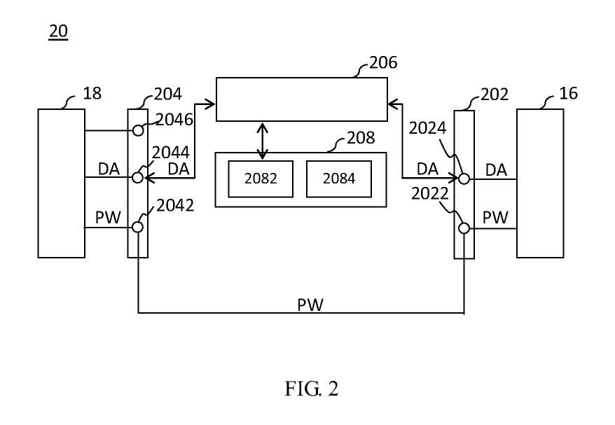

Referring to FIG. 2, there is shown a schematic block diagram of the switching module 20 of FIG. 1 according to an embodiment of the present invention. As shown in FIG. 2, the switching module 20 further comprises a first transmission module 202, a second transmission module 204, a switching unit 206, and a hub module 208.

The first transmission module 202 has a first power connection terminal 2022 and a first data connection terminal 2024. The first transmission module 202 is connected to the connector 16 by means of the first power connection terminal 2022 and the first data connection terminal 2024, such that the data DA and the power PW can be transmitted between the first transmission module 202 and the electronic device 2 via the connector 16.

The second transmission module 204 has a second power connection terminal 2042, a second data connection terminal 2044, and a control terminal 2046. The second transmission module 204 is connected to the connector 18 by means of the second power connection terminal 2042 and the second data connection terminal 2044, such that the data DA and the power PW can be transmitted between the second transmission module 204 and the electronic device 4 via the connector 18.

The second power connection terminal 2042 and the first power connection terminal 2022 are connected. The control terminal 2046 switches the electronic device 4 between the master control configuration and the slave control configuration. That is to say, the electronic device 4 operates in a master mode or a slave mode, depending on the control terminal 2046.

The switching unit 206 connects the first data connection terminal 2024 and the second data connection terminal 2044.

The hub module 208 has a connecting unit 2082 and a routing unit 2084. The hub module 208 is connected to the switching unit 206 via the connecting unit 2082. A plurality of path configurations (not shown) is formed between the hub module 208 and the switching unit 206 to facilitate transmission of the data DA and the power PW between the electronic devices 2, 4.

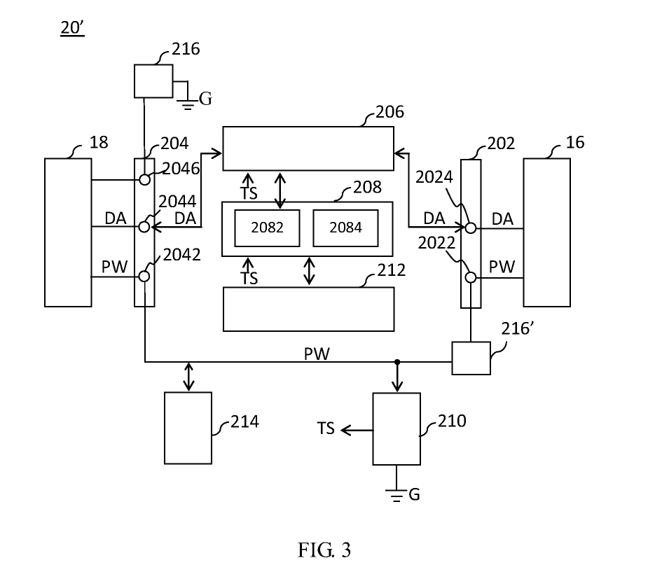

Referring to FIG. 3, there is shown a schematic block diagram of a switching module 20′ of FIG. 1 according to another embodiment of the present invention. As shown in FIG. 3, the switching module 20′ not only comprises the first transmission module 202, the second transmission module 204, the switching unit 206, and the hub module 208 which are shown in FIG. 2, but also comprises a voltage dividing unit 210, an expansion unit 212, a battery unit 214, and the switch elements 216, 216′.

The voltage dividing unit 210 is connected to the first power connection terminal 2022 and adapted to retrieve the power PW from the first power connection terminal 2022 so as to generate a trigger signal TS. When subjected to the control exercised by the trigger signal TS, the path configurations between the switching unit 206 and the hub module 208 undergo switching automatically.

The expansion unit 212 and the hub module 208 are connected. The data DA is transmitted between the expansion unit 212 and the electronic devices 2, 4 through the path configurations. For example, the expansion unit 212 is at least one of an electrical connection interface, a high definition multimedia interface, a card reader, and a wireless communication circuit.

The battery unit 214 is connected to the first power connection terminal 2022 and the second power connection terminal 2042. The battery unit 214 stores the power PW required for operation of the electronic devices 2, 4 and thus supplies the power PW to the electronic devices 2, 4.

The switch element 216 is connected to a ground G and the control terminal 2046 of the second transmission module 204. A user presses the switch element 216 to determine and change the state of electrical connection between the control terminal 2046 and the ground G. The switch element 216′ connects the first power connection terminal 2022 and the second power connection terminal 2042. A user presses the switch element 216′ to determine and change the state of electrical connection between the first power connection terminal 2022 and the second power connection terminal 2042.

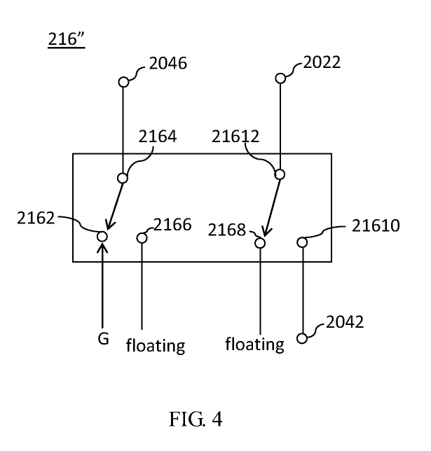

For instance, referring to FIG. 4, the switch elements 216, 216′ are each exemplified by a switcher 216″ having therein six built-in switching terminals. The switch element 216 has a first switching terminal 2162, a second switching terminal 2164, a third switching terminal 2166, a fourth switching terminal 2168, a fifth switching terminal 21610, and a sixth switching terminal 21612.

The first switching terminal 2162 is connected to the ground G. The second switching terminal 2164 and the control terminal 2046 are connected. The third switching terminal 2166 is floating. The fourth switching terminal 2168 is floating. The fifth switching terminal 21610 is connected to the second power connection terminal 2042. The sixth switching unit 21612 is connected to the first power connection terminal 2022. The switching module 20′ is designed in such a manner that, depending on the switching of the switch element 216, the user can choose to change the path configurations of the switching unit 206 and the hub module 208 manually.

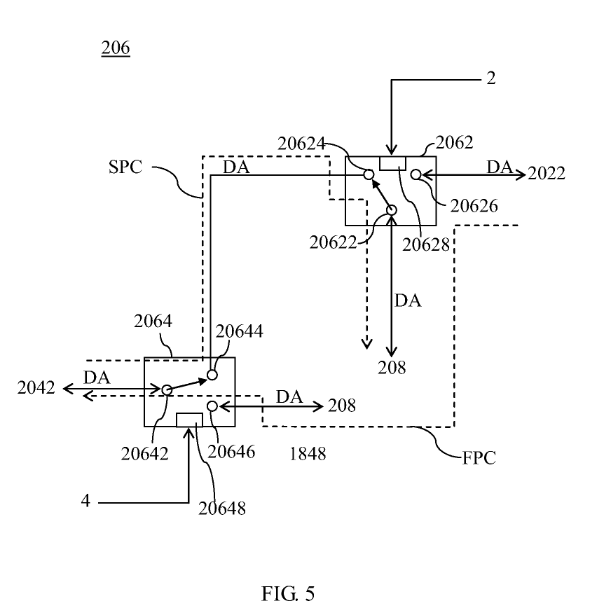

Referring to FIG. 5, there is shown a schematic block diagram of the switching units of FIG. 2 or FIG. 3. As shown in FIG. 5, the switching unit 206 comprises two switching units. In this embodiment, the switching unit 206 is exemplified by a first switching unit 2062 and a second switching unit 2064.

The first switching unit 2062 has a master terminal 20622, a first control terminal 20624, a second control terminal 20626, and a selection terminal 20628. The second switching unit 2064 has a master terminal 20642, a first control terminal 20644, a second control terminal 20646, and a selection terminal 20648.

The terminal-specific connection between the first switching unit 2062 and the second switching unit 2064 is achieved by connecting the hub module 208 to a master terminal 20622 of the first switching unit 2062, connecting a first control terminal 20624 of the first switching unit 2062 to a first control terminal 20644 of the second switching unit 2064, connecting a second control terminal 20626 of the first switching unit 2062 to the first power connection terminal 2022 of the first transmission module 202, connecting a master terminal 20642 of the second switching unit 2064 to a second power connection terminal 2042 of the second transmission module 204, and connecting the hub module 208 to the second control terminal 20646 of the second switching unit 2064.

The hub module 208, together with switching from terminals of the first switching unit 2062 to the second switching unit 2064 and vice versa, it is feasible to form a first path configuration (FPC) and a second path configuration (SPC) in the switching module 20.

The first path configuration FPC comprises routes formed from the second control terminal 20626 and the master terminal 20622 of the first switching unit 2062, the second control terminal 20646 and the master terminal 20642 of the second switching unit 2064, and the hub module 208, respectively, so as to transmit the data DA between the electronic devices 2, 4.

The second path configuration SPC comprises routes formed from the master terminal 20642 and the first control terminal 20644 of the second switching unit 2064, the first control terminal 20624 and the master terminal 20622 of the first switching unit 2062, and the hub module 208, respectively, so as to transmit the data DA between the electronic device 4 and the expansion unit 212.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A multifunction earpiece device for receiving a sound signal generated from one of a plurality of electronic devices and transmitting at least one of data and power between the electronic devices, the multifunction earpiece device comprising:
a casing having a receiving space therein and a plurality of holes;
a speaker unit having a plurality of sound lines and a plurality of speaker singles, the sound lines each having an end inserted from one of the holes into the receiving space and exiting another one of the holes to connect to the electronic devices for receiving the sound signal, the sound lines each having another end connected to a corresponding one of the speaker singles, the speaker singles converting the sound signal into a sound;
a plurality of connectors disposed in the receiving space and protruding from the receiving space through the holes to connect to the electronic devices; and
a switching module having a plurality of path configurations, disposed in the receiving space, connected to the connectors, and adapted to change a direction of transmission of the data and the power between the electronic devices by the path configurations.

2. The multifunction earpiece device of claim 1, wherein the switching module further comprises:
a first transmission module having a first power connection terminal and a first data connection terminal, the first transmission module connecting to one of the connectors and connecting to one of the electronic devices through the first power connection terminal and the first data connection terminal and via one of the connectors to transmit the data and the power;
a second transmission module having a second power connection terminal, a second data connection terminal, and a control terminal, connecting to another one of the connectors, and connecting to another one of the electronic devices through the second power connection terminal and the second data connection terminal, wherein the second power connection terminal connects to the first power connection terminal, and the control terminal switches the electronic devices connected to the second transmission module between a master control configuration and a slave control configuration;
a switching unit connected to the first data connection terminal and the second data connection terminal; and
a hub module having a plurality of connecting units and a plurality of routing units and connecting to the switching module via the connecting unit, wherein the hub module and the switching module together form a plurality of path configurations therebetween for transmitting the data between the electronic devices.

3. The multifunction earpiece device of claim 2, wherein the switching module further comprises a voltage dividing unit connected to the first power connection terminal and adapted to retrieve the power from the first power connection terminal to generate a trigger signal, wherein the trigger signal changes the path configurations between the switching unit and the hub module automatically.

4. The multifunction earpiece device of claim 3, wherein the switching module further comprises an expansion unit connected to the hub module, wherein the data and the power are transmitted between the expansion unit and the electronic devices by the path configurations.

5. The multifunction earpiece device of claim 4, wherein the expansion unit is at least one of an electrical connection interface, a high definition multimedia interface, a card reader, and a wireless communication circuit.

6. The multifunction earpiece device of claim 2, further comprising a battery unit connected to the first power connection terminal and the second power connection terminal and adapted to store the power required for operation of the electronic devices and thereby supply the power to the electronic devices.

7. The multifunction earpiece device of claim 2, further comprising a switch element connected to a ground and the control terminal of the second transmission module, such that the switch element is pressed to determine a state of electrical connection between the control terminal and the ground, wherein the switch element connects the first power connection terminal and the second power connection terminal, such that the switch element is pressed to determine and change a state of electrical connection between the first power connection terminal and the second power connection terminal.

8. The multifunction earpiece device of claim 7, wherein one of the switch elements has a first switching terminal, a second switching terminal, a third switching terminal, a fourth switching terminal, a fifth switching terminal, and a sixth switching terminal, the first switching terminal being connected to the ground, the second switching terminal being connected to the control terminal, the third switching terminal floating, the fourth switching terminal floating, the fifth switching terminal being connected to the second power connection terminal, and the sixth switching unit being connected to the first power connection terminal.

9. The multifunction earpiece device of claim 1, wherein the connectors are at least one of standard universal serial buses, mini universal serial buses, micro universal serial buses, Apple 30-pin connectors, and Apple 8-pin connectors.
